(19) United States
(12) Patent Application Publication
(10) Pub. No.: US 2008/0220262 A1
(43) Pub. Date: Sep. 11, 2008

(54) Coating for External Device for Thermo-Optical Control of Space Vehicles, Method for Forming Same by Micro-Arcs in Ionized Environment, and Device Coated with Same

(75) Inventor: Michel Plotto, Mons (FR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Astrium SAS, Paris (FR)

(21) Appl. No.: 11/996,660

(22) PCT Filed: Jun. 29, 2006
(86) PCT No.: PCT/FR06/01533

§ 371 Date: Jan. 24, 2008

(30) Foreign Application Priority Data
Jul. 26, 2005 (FR) 0507968

(51) Int. Cl. B32B 17/06; C25D 5/10; C25D 5/18

(52) U.S. Cl. 428/432; 205/170; 205/108

(57) ABSTRACT

The invention concerns a coating produced by conversion treatment of an outer surface of a semiconductor metal support component (12) and comprising an inner layer (11) adhering to the support component (12) and accepting differential expansion constraints relative thereto, and an outer layer (19) having low solar absorptivity characteristic α and the inner (11) and outer (10) layers having jointly a high hemispheric emissivity characteristic ε such that the α/ε ration is less than about 30%, and preferably less than 20%, the outer (10) and inner (11) layers consisting of different ceramics from one layer to the other and derived from crystalline forms different from the semiconductor metal or alloy of the metal support component (12). The invention is applicable to radiative outer surfaces of space vehicles.

The present invention relates to a coating for an external device for thermooptically controlling elements of space vehicles, in particular satellites, and capable of covering and/or constituting all the external radiative surfaces of a space vehicle.

The invention also relates to a process for forming or producing this coating by micro-arcs in an ionized medium, in particular in an aqueous bath, and also to an external device for thermooptically controlling at least one element of a space vehicle, the device having at least one external surface intended to be turned toward space when the space vehicle moves in space, and said external surface of which is coated with and/or consists of a coating according to the invention.

It is well known that thermal control is generally necessary on board vehicles exposed to the space environment, such as satellites, interplanetary probes, orbital probes, etc., in order to keep the electronic components or any other element on board such vehicles within their temperature range for correct operation.

This space environment is characterized above all by the complete absence of an atmosphere. The various thermal or thermooptic control methods currently employed are mainly designed to balance, within the space vehicle, the heat fluxes received and emitted by radiation, while maintaining an acceptable temperature level for the operation of the onboard elements, especially the optical instruments and the electronic equipment.

The thermal environment in space comprises the following heat sources:
the radiation emitted by the sun (about 1400 W/m² at 1 AU (astronomical unit));
the radiation emitted by other distant heavenly bodies;
the radiation emitted by heavenly bodies and reflected by nearby planets (for example the reflection by the Earth of the solar radiation represents about 500 W/m² at 200 km from the Earth);
the radiation emitted by planets near a space vehicle in question (for example an artificial satellite which, at 200 km from the Earth, receives from the latter radiation with a power of about 200 W/m²);
the cosmic rays; and
the kinetic energy of space particles.

It may be considered that the heating of a space vehicle due to cosmic rays or to collisions between this space vehicle and space particles is negligible.

Added to the amount of energy absorbed as heat by the space vehicle is the amount of heat produced inside the space vehicle, and practically all these energies must be dissipated by radiation into space, constituting a heat sink, the temperature of which is close to 4 kelvin.

These various radiative heat exchanges take place in different spectral ranges:
98% of the solar energy is emitted at wavelengths of between 0.2 and 3 μm (the reflection of this energy by the planets takes place within the same spectral range); the solar absorptivity α characterizes the capability of the surface of a material to absorb these wavelengths (which correspond to the visible range); and
99% of the energy radiated by a body at a moderate temperature is emitted at wavelengths greater than 3 μm (in the infrared range); it is in this way that the Earth or a space vehicle radiates energy into cold space; the emissivity ε (or total emission factor) characterizes the capability of a material to emit or absorb in the infrared band, and the heat fluxes are governed by the Stefan-Boltzmann law.

In addition to a particular thermal environment, the space vehicle may be exposed to a highly stressful particulate and radiative environment:
monoatomic oxygen (ATOX) is highly devastating through its oxidizing and kinetic action (4 m/s) for satellites following near-Earth orbits at 300 km;
ultraviolet rays, which provide only little heat, greatly increase the aging of certain materials, particularly certain polymers (breaking or recombining the chains thereof);
γ radiation has destructive energetic effects on certain materials and components; and
electrons and protons, in addition to having an electrical impact, resulting in the generation of electrical voltages that may produce arcs, may cause aging of materials.

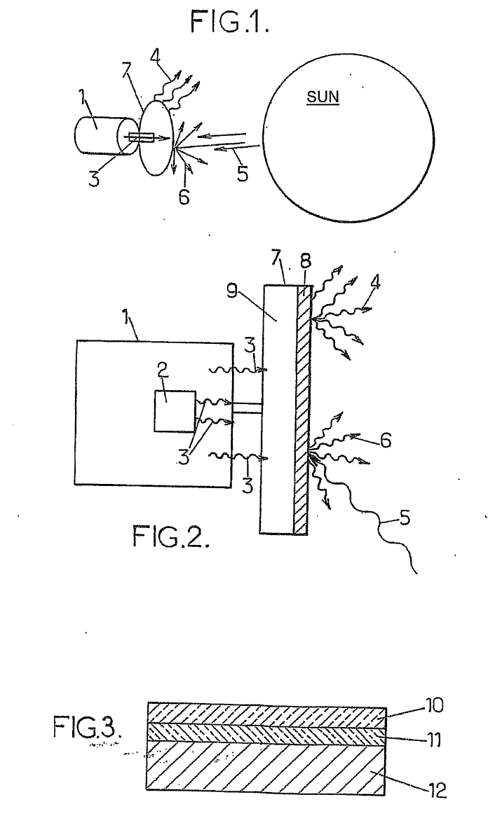

To make it easier to understand the foregoing, the stresses imposed by the thermal environment in space on a space vehicle, such as an artificial satellite, will now be described with reference to FIGS. 1 and 2. FIGS. 1 and 2 show schematically a space vehicle 1 equipped with an external thermooptic control device 7 that receives the solar radiation 5 and discharges internal heat 3 dissipated in particular by equipment 2 internal to the space vehicle 1. To simplify the representation, the device 7 represented substantially in the form of a circular disk and associated with the generally cylindrical structure of the vehicle 1 in FIG. 1, is schematically represented in diametral cross section, and therefore with a flat parallelepipedal shape associated with a platform, again in diametral cross section of parallelepipedal shape of the vehicle 1 in FIG. 2.

To allow the space vehicle 1 and all the equipment 2 in this vehicle to dissipate their internal heat 3 (shown by the single arrow passing through the support arm of the device 7 by the vehicle 1 in FIG. 1) by radiation 4, while still possibly maintaining incident solar radiation flux 5, it is necessary to use an external thermooptic control device such as the device 7, the external face 8 of which (see FIG. 2), that is to say the face turned toward space, is highly radiative, that is to say having a high thermal emissivity ε, and, possibly, and also preferably, highly reflective, that is to say having a low solar absorptivity α, in order to maximize the reflected flux 6. In addition, for thermal conductivity reasons, and possibly because of the accumulation of electric charges created by the solar radiation 5, the internal face 9 of the device 7, that is to say the face of the device 7 facing the space vehicle 1, must be sufficiently electrically conductive to avoid any destructive electrostatic discharge.

If the internal heat flux 3 of the vehicle 1 is denoted by Φᵥ, the flux of the radiation 4 emitted by the external surface 8 of the device 7 into cold space is denoted by Φₑ, the flux of the incident solar radiation 5 is denoted by Φₛ and the reflected solar flux 6 is denoted by Φᵣ, then Φᵣ=(1−α)Φₛ and Φₑ may be defined by the following formula:

Φₑ=f(ε,T)·(Φᵥ+αΦₛ)

where f(ε,T) is a function of the emissivity ε and of the absolute temperature T, this function increasing when the emissivity ε increases.

The thermooptic control devices currently used may be put into two general categories:
“active” devices employing active thermal control methods using temperature regulation techniques; these active methods acquire the use of movable parts, such as radiators with movable flaps, and are energy consumers. The reliability of these devices is therefore affected by the wear of the movable parts and by the use of electronic components. However, these methods have the advantage of allowing finer control inside the space vehicle; and
“passive” devices which employ passive thermal control methods based on a suitable geometric design of the space vehicle and on a judicious choice of the constituent materials of the device, according to their physical, electrical and thermal properties. These methods do not consume energy and use no moving part, so that the passive devices are therefore extremely reliable. These passive methods involve heat sinks with a high calorific capacity, fusible materials providing the energy needed for phase changes, thermal insulators, such as glass/epoxy composites, and thermooptic coatings.

The passive devices, for example external radiators or solar shields, are most of the time covered with a coating allowing the incident solar radiation to be effectively reflected (the coating therefore has a low absorptivity coefficient α), while still having a very high emissivity factor ε so as to allow it to discharge the heat into cold space, for which reason these coatings are called “cold coatings”.

The cold coatings of the prior art for passive thermooptic control devices are produced by white paints, SSM (second surface mirror) coatings, consisting of two dioptric interfaces, the first letting the light through, the second serving as a mirror, or optical solar reflectors commonly called OSRs (optical sun reflectors), which are characterized by a low absorptivity coefficient α (typically between 0.1 and 0.2) and a high hemispherical emissivity coefficient ε (typically between 0.8 and 0.9).

White paints known for their space application and identified below by their commercial names are defined below by their electrically conducting or nonconducting property, the nature of their binder and of their pigments, and also by the values of the coefficients α and ε:
PSB:
   nonconductive white paint,
   binder: potassium silicate,
   pigment: zinc orthotitanate and
   α=0.13; ε=0.80;
SG 11 FD:
   nonconductive white paint,
   binder: silicone, with the brand name RTV 121 from Rhône-Poulenc and purified by the CNES (Centre National d'Etudes Spatiales),
   pigment: zinc orthotitanate coated with potassium silicate and
   α=0.12; ε=0.88;
SG 120 FD
   nonconductive white paint,
   binder: RTV 121 silicone (Rhône-Poulenc) purified by the CNES,
   pigment: calcined zinc oxide and
   α=0.17; ε=0.87;
PSG 120 FD:
   nonconductive white paint,
   binder: RTV 121 silicone (Rhône-Poulenc) purified by the CNES,
   pigment: zinc oxide with the brand name SP 500 from the United States company New Jersey Zinc Co) and
   α=0.17; ε=0.87;
S13GLO:
   nonconductive white paint,
   binder: silicone, with the brand name RTV 602 from the United States company General Electric, purified by the United States company IITRI,
   pigment: SP 500 zinc oxide (New Jersey Zinc Co) and
   α=0.18; ε=0.90;
Z93:
   nonconductive white paint,

1binder: potassium silicate,
pigment: SP 500 zinc oxide (New Jersey Zinc Co) and
α−0.17; ε=0.93;
A276:
   nonconductive white paint,
   binder: polyurethane,
   pigment: titanium dioxide,
   α−0.25; ε=0.89;
PCBZ:
   conductive white paint,
   binder: silicone with the brand name RHODORSIL 10336 (Rhône-Poulenc) purified by the CNES,
   pigment: zinc orthostannate and
   α=0.26; ε=0.83;
PCBT:
   conductive white paint
   binder: silicone with the brand name R4-3117 from the United States company Dow Corning purified by the CNES,
   pigment: tin orthotitanate and
   α=0.26; ε=0.80;
PCB 119:
   conductive white paint,
   binder: RHODORSIL 10336 silicone (Rhône-Poulenc) purified by the CNES,
   pigment: doped zinc orthotitanate and
   α=0.15; ε=0.83;
SGC 21:
   antistatic white paint (highly electrically conductive),
   binder: RTV 121 silicone (Rhône-Poulenc) purified by the CNES,
   pigment: doped tin oxide and zinc orthotitanate and
   α=0.35; ε=0.87; and
SCK 5:
   antistatic white paint (highly conductive),
   binder: resin with the brand name K from the German company Wacker, purified by the CNES,
   pigment: doped pigments and zinc orthotitanate and
   α=0.20; ε=0.91

The cold coatings commonly called SSM and widely used are the following:
a bilayer coating having an external layer (turned toward space) made of polyfluoroethylene (PFE) forming a support and an internal layer made of aluminum, for which α=0.14 and ε depends on the thickness of the PFE;
a bilayer coating having an external layer of PFE and an internal layer made of silver, for which α=0.09 and ε depends on the thickness of the PFE;
a bilayer having a polyimide external layer and an aluminum internal layer, for which α and ε are dependent on the thickness of the polyimide;
a bilayer coating having a polyester (PE) external layer and an aluminum internal layer, for which α and ε are dependent on the thickness of the PE; and
a bilayer coating having a polyetherimide (PEI) external layer and a silver internal layer, for which α=0.16 and ε depends on the thickness of the PEI.

The cold coatings commonly called OSRs are glass platelets (Corning 7940 fused silica, cerium-doped glass or CMX glass) coated with silver on the internal face.

The passive devices of the SSM and OSR types may furthermore be covered, on the outside, with a layer of indium tin oxide, which is an electrically conductive transparent layer, and they are bonded to structural panels using organic adhesives.

A drawback of these external thermooptic coatings called cold coatings (paints, OSRs, SSMs) is that they reach their limit when the space environment hardens, especially when the temperature, the radiation and the electrostatic charge effects increase, in particular when the space vehicle approaches the Sun (and is typically at a distance of between 0.2 and 0.5 AU from the latter).

The binders of the paints (with the exception of the silicate binders) and the adhesives of the SSM and OSR devices comprise at least one organic constituent that cannot withstand excessively high temperatures (in all cases certainly not above 400° C.). In contrast, the paints using silicate binders have excessively high solar absorptivity characteristics and are highly radiation-sensitive. Furthermore, in the case of paints and OSR devices, the difference between their expansion coefficient and that of the support is a greatly limiting factor at high temperature.

SSM cold coatings cause electrostatic charge problems. Moreover, all these cold coatings (paints, SSMs, OSRs) lose their quality in the presence of strong radiation (in particular ultraviolet radiation) and a proton flux, such as those commonly encountered in the space environment, in particular when a space vehicle approaches the Sun.

For missions close to the Sun, which require the use of materials resistant to the high temperatures encountered (ranging from 400 to 600° C.), it has already been envisioned to use, firstly, metals. However, since metals generally are good electrical conductors, they have the drawback of having quite a low emissivity ε. Secondly, it has been envisioned to use an OSR-type ceramic to form the external surface of an external thermooptic control device for a space vehicle suitable for this type of mission, such a ceramic being transparent, such as glass, and its internal surface (turned toward the device) being covered with a reflective material. However, since this OSR-type ceramic is an amorphous material, when this coating is exposed to radiation, such as ultraviolet rays and/or protons, some of its characteristics, especially its optical transmission characteristics, change unfavorably over time. Furthermore, since this amorphous material is electrically highly insulating, it is not capable of discharging the electrical charges coming from space. Very high potentials are thus established between the structure of the space vehicle and this amorphous coating, up to the breakdown voltages that destroy electronic components.

The problem at the basis of the invention is to propose a suitable thermooptic coating intended essentially for covering external surfaces of passive thermooptic control devices, optionally combined with active thermooptic control devices, the coating according to the invention remedying the various drawbacks of the coatings of the prior art, as presented above.

One object of the invention is to obtain a coating for an external device for thermooptically controlling at least one element of a space vehicle, the coating according to the invention having very specific characteristics, useful for thermal control space applications, such as those described above, and especially a very high hemispherical emissivity and advantageously, and simultaneously, a very low solar absorptivity, together with, in addition, a very good temperature resistance and an absence of aging or very limited aging in a harsh environment such as the space environment.

For this purpose, the invention proposes a coating for an external device for thermooptically controlling at least one element of a space vehicle, which is characterized in that it is produced by a conversion treatment, for converting at least one external surface of at least one metallic support part of said external device, and is resistant to radiative stresses encountered in space, said coating comprising:
an internal layer, in contact with said external surface of the metallic support part, which is highly adherent to said metallic support part and withstands differential expansion stresses relative to said metallic support part; and
an external layer, in contact on one side with the internal layer and on the other side with the space environment in which the device moves, said external layer having a low solar absorptivity characteristic α,
the external and internal layers covering said external surface of said metallic support part consisting of ceramics differing from one layer to the other, and obtained from different crystalline forms of the metal or alloy of said metallic support part, said crystalline forms of the external and internal layers interpenetrating at the interface between the two layers, and said crystalline form of the internal layer interpenetrating with the metal or alloy of said metallic support part,
said external and internal layers together having a high hemispherical emissivity characteristic ε and
the solar absorptivity characteristics α of the external layer and the emissivity characteristics ε of both the external and internal layers being such that the ratio α/ε is less than about 30% and preferably less than 20%.

Thus, depending on the nature of the metal or the metallic alloy constituting the metallic support part on its external surface or surfaces to be coated, the ceramics of the external and internal layers are obtained from crystalline forms such as to provide the high hemispherical emissivity required for the envisioned application, whereas the ceramic or ceramics constituting the internal layer is or are such as to provide the strong adhesion of this internal layer to the metallic support part and the withstanding of the differential expansion stresses of this internal ceramic layer relative to the metallic support part, such that the ceramic or ceramics of the external layer is or are such as to provide the low solar absorptivity required for the envisioned application, and also the ratio of the absorptivity to the emissivity of the coating is favorably low, the coating thus consisting of the two aforementioned layers providing good resistance to the radiative stresses encountered in space.

Advantageously, through the choice of the ceramic or ceramics of which it is made, the external layer has a solar absorptivity characteristic of less than about 0.20 and preferably less than 0.15.

Likewise, through the choice of the ceramics of which they are made, said external and internal layers together have an emissivity characteristic ε of greater than about 0.75 and preferably between 0.8 and 0.9.

The coating according to the invention thus has the great advantage of a low ratio of the solar absorptivity α to the hemispherical emissivity ε (α/ε<30% and preferably <20%).

Furthermore, the metal or the metallic alloy of the support part may be chosen so that the ceramics obtained from different crystalline forms of this metal or this alloy provide a coating which is resistant to temperatures of at least 200° C.

Likewise, because of the constituent ceramic(s) of the internal layer of the coating, there is advantageously interpenetration of the crystalline form or forms of said internal layer with the metal or alloy of the metallic support part. Likewise, the crystalline forms of the external and internal layers advantageously interpenetrate at the interface between the two layers.

According to one advantageous feature of the invention, the ceramics of the layers of the coating are crystalline forms of a “semiconducting”-type metal or alloy, or one having a “valve effect”, of the metallic support part, since these “semiconducting” metals, such as aluminum and titanium, and also magnesium, hafnium and zirconium, have the advantage of having a beneficial strength/weight ratio and are suitable for a wide range of applications, such as in astronautics and aeronautics, especially for movable parts with high mechanical deformation loads and stresses on the one hand, and are advantageously suitable, on the other hand, for the formation of micro-arcs during deposition of such a coating by an electrolytic oxidative conversion process, by plasma micro-arcs, by a physico-chemical reaction to convert the treated semiconducting metal or alloy, for the purpose of obtaining a ceramic coating on the surface of a metallic part made of this semiconducting metal or alloy, as explained below.

Preferably, to produce an internal layer of excellent quality, this internal layer is a ceramic withstanding large deformations, possibly in excess of 100%, and essentially consisting of salts, hydroxides and the oxide phase of lowest enthalpy of the metal or alloy of said metallic support part.

Likewise, advantageously according to the invention, the external layer is of excellent quality when this external layer is made of a white ceramic denser than that of the internal layer and essentially consisting of the oxide phase of at least one highly enthalpic crystalline form of the metal or alloy of said metallic support part.

To advantageously improve the emissivity of such a coating, the external layer is covered, toward the outside, by a transparent vitrified ceramic layer, which provides this improvement in emissivity while maintaining the low absorptivity of said external layer.

The ceramic coating of the invention is therefore always supported by an electrically conductive metallic material. For reasons of lightness, the metal or alloy of this material is advantageously aluminum or an aluminum alloy, titanium or a titanium alloy, this being recommended for very high operating temperatures (above 300° C.), or else, possibly, magnesium or a magnesium alloy.

When the coating according to the invention is produced by a conversion treatment, for converting at least_one_external surface of a support part made of aluminum or aluminum alloy, its internal layer is advantageously an aluminum/alumina interface layer having a high concentration of salts, of hydroxides and of the bohemite phase of aluminum oxide Al₂O₃, whereas its external layer is made of a dense white ceramic, essentially consisting of aluminum oxide of the α-Al₂O₃ crystal form called corundum.

In this case, to obtain strong whiteness and thus improve the low absorptivity characteristic, thanks to a very low surface resistivity, the outermost portion of the external layer of the coating is produced with a very high concentration, preferably greater than 90%, of corundum.

In these various embodiments of the coating produced by a treatment of converting the aluminum or one of its alloys, said high concentration of low-density forms (salts, hydroxides and Al₂O₃ bohemite phase) of the internal layer at the interface with the support metal or metal alloy improves the resistance to large thermal amplitudes, for example resulting from the temperature passing from −100° C. to +300° C.

Alternatively, when the coating according to the invention is produced by a conversion treatment, for converting at least one external surface of a support part made of titanium or titanium alloy, its internal layer is advantageously an interfacial layer between, on the one hand, the titanium or said titanium alloy and, on the other hand, at least one amorphous titanium oxide, and salts, hydroxides and brookite and anatase phases of titanium oxide TiO₂, whereas its external layer is made of a dense white ceramic essentially consisting of titanium oxide in the α-TiO₂ crystal form called the rutile form.

One advantage of this coating is that the high concentration of low-density forms that constitute the salts, hydroxides and brookite and anatase phases of TiO₂ in the internal layer at the interface with the support metal or metal alloy improves, in this case too, the resistance to large thermal differences, such as the ambient temperature passing to a temperature of +700° C.

Furthermore, to improve the low absorptivity characteristics while still maintaining a high emissivity, the outermost portion of the external layer of the coating according to the invention has a high concentration, preferably greater than 70%, of the rutile form.

What is thus obtained is a coating exhibiting excellent properties specific to thermal control applications in space, such as a high hemispherical emissivity, a low solar absorptivity, good temperature resistance and low aging in a space environment, with furthermore very good adhesion to the metallic support and flexibility of the internal layer of the coating accommodating large strains, in particular thermoelastic and bending strains.

Standard processes, the means for implementation, the raw material, the energy source and the productivity of which are summarized and collated in the table below, may be used to produce such coatings.

| | | ENERGY | |
|---|---|---|---|
| PROCESS | RAW MATERIAL | SOURCE | PRODUCTIVITY |
| Oxyacetylene | Powder, wire | Combustion of | 1 to 2 kg/h |
| flame | or sheathed | a gas | |
| | cord | | |
| Arc-wire | Metal wire + | Electric arc | A few kg/h |
| | gas | | |
| Plasma torch | Powder | Recombination | 1 to 2 kg/h |
| | | of a gas | |
| Hypersonic | Powder | Combustion of | A few kg/h |
| processes | | a gas | |

These known processes have a number of major drawbacks. Firstly, they are very expensive to implement. Secondly, the adjustments for obtaining good adhesion of a coating to a metallic support are difficult to achieve and, in general, the metallic substrate or support must be maintained at a high temperature. In addition, the uniformity of the coating over the entire surface of the metallic part to be coated is difficult to achieve, unless expensive mechanization is provided to ensure implementation of the process.

Another known process, which does give a uniform coating, is anodic oxidation in an electrolytic bath. Unfortunately, this process does not produce a white coating of low solar absorptivity. In addition, large temperature differences during implementation of the process create stresses in the ceramic of the coating, to the point of causing crazing and flaking of the ceramic, because of a large difference between the expansion coefficient of the support metal or alloy and that of the ceramic.

To remedy the aforementioned drawbacks of the known processes presented above, the subject of the invention is also a process for forming a ceramic coating, suitable for the invention and as presented above, on at least one external surface of at least one support part made of a “semiconducting” metal or alloy, or one having a “valve effect”, which is a development and an improvement of the oxidizing electrolytic process for obtaining a ceramic coating on the surface of a semiconducting metal or alloy described in the patent document FR 2 808 291 or EP 1 276 920, to which the reader may refer for further details on this subject. It is sufficient to recall that this patent document discloses an oxidizing electrolytic process by means of plasma micro-arcs for the purpose of obtaining a ceramic coating on the surface of a metal having semiconductor properties, such as aluminum, titanium, magnesium, hafnium, zirconium and their alloys, via physico-chemical reaction transforming the treated metal or alloy, the process consisting in immersing the metal part to be coated in an electrolytic bath consisting of an aqueous solution of an alkali metal hydroxide, such as potassium hydroxide or sodium hydroxide, and of an oxyacid salt of an alkali metal, the metal part forming one of the electrodes, and in applying a voltage of generally triangular waveform to the electrodes, said waveform having at least a rising edge and a falling edge, with a form factor that varies over the course of the process, generating a current controlled in its intensity, its waveform and its positive intensity/negative intensity ratio.

This oxidizing process by means of plasma micro-arcs in an aqueous bath makes it possible to cover semiconducting metals with a ceramic having suitable mechanical hardness, tribological (low friction coefficient) and anticorrosion properties.

The process according to the present invention includes substantial modifications and adaptations of the aforementioned known process, in order to obtain a ceramic coating having desired thermooptic properties, namely:
an external layer having a low solar absorptivity coefficient α and a high hemispherical emissivity coefficient ε in combination with an internal layer; and
the internal layer, between the external layer and the metallic support part, ensuring excellent adhesion to the metal or alloy of this support part, and making it possible to accommodate large expansion differences between the external layer of the coating on the one hand and the metal or alloy of the support part on the other.

For this purpose, the process according to the invention, for forming a ceramic coating as presented above on at least one external surface of at least one support part made of a metal or alloy called a “semiconducting” metal or alloy, or one having a “valve effect”, by electrolytic oxidizing conversion, by means of micro-arcs in an ionized medium, of said semiconducting metal or alloy, is characterized in that said electrolytic conversion is obtained by a multi-step treatment in an aqueous bath or in a gaseous plasma, and in that, after a first step consisting in forming an electrically insulating, essentially hydroxide, layer then a second step, consisting in forming the external ceramic layer of the coating beneath said electrically insulating layer, a third step consists in forming the ceramic of the internal layer, also beneath said electrically insulating layer.

If, as in the aforementioned patent document, the electrolytic conversion is provided in an aqueous bath and the second step of forming the external layer of the coating is carried out in an aqueous electrolyte comprising at least one oxyacid salt of an alkaline metal and a hydroxide of an alkaline metal, the process according to the present invention is characterized in that, in the second step, the aqueous electrolyte has a low concentration of oxyacid salt of said alkaline metal, such as potassium or sodium, and a low concentration of hydroxide and/or peroxide of an alkaline metal, and the third step is carried out in a bath having a very high concentration of oxyacid salt of an alkaline metal, so as to promote hydroxide growth with an electric voltage/current profile applied to the electrodes, the anode of which at least partly consists of said support part made of semiconducting metal or alloy, chosen in such a way that the micro-arcs are extinguished rapidly so as to maintain a low oxide formation temperature.

Advantageously, the second step is continued until the micro-arc strike voltages exceed about 1000 volts, thereby promoting the creation of micro-arcs that are satisfactory in terms of number and quality.

Furthermore, during the second step, advantageously the electrolyte is strongly cooled so as to keep the ceramic deposit cold. This is because the insulation resistance decreases when the temperature increases. Now, to have the largest joule effect during creation of an arc, the insulation resistance must be as high as possible, and therefore the temperature as low as possible.

Also preferably, so as to further densify the ceramic deposit, during the second step ultrasonic waves are transmitted through the electrolyte during this step.

To promote crystalline oxide growth, which makes the coating more stable over time under the impact of high-energy waves and particles striking it, during the second step, at least one salt, for example a copper and/or lanthanum salt, is advantageously introduced into the electrolytic bath so as to promote the growth of an oxide form of high enthalpy.

Also advantageously, during the third step, the temperature of the electrolyte is increased, for example by reducing the intensity of its circulation and, preferably, the entire bath is kept under pressure in an autoclave container so as to prevent the water of the electrolyte from boiling. Thus, by increasing the temperature of the electrolyte, the temperature of the insulator, and therefore its resistivity, is increased.

The process of the invention advantageously includes a fourth step, which may consist in removing the electrically insulating layer formed during the first step.

In this case, the removal of the electrically insulating layer may be carried out in a bath for dissolving hydroxides and salts, for example a dilute hydrofluoric acid bath or a potassium hydroxide bath. In this case, during the fourth step, it is advantageous to simultaneously transmit ultrasonic waves through the dissolving bath so as to exert compacting action for eliminating the pores remaining in the ceramic deposit after removal of the electrically insulating layer.

As a variant, the fourth step of removing the electrically insulating layer may be carried out by means of at least one mechanical operation, for example by micro-peening and/or by polishing, so as to remove a porous surface portion rich in hydroxides and salts, especially silicates, of the ceramic deposit.

However, it also possible, according to a preferred method of implementing the process of the invention, for the latter to include a fourth step consisting in vitrifying the electrically insulating layer produced during the first step, so as to make it transparent and to improve the emissivity without degrading the solar reflection, the vitrification comprising a dehydration of hydroxides, for example through the action of a high temperature in a furnace or by using a pulsed high-power laser, this step making it possible to improve the emissivity further, without degrading the solar reflectivity.

The subject of the invention is also an external device for thermooptically controlling at least one element of a space vehicle, having at least one external surface intended to be turned toward space when the space vehicle moves in said space, and is coated with a coating resistant to the thermal and radiative stresses specific to the space environment, and having a high emissivity and a low absorptivity, and the external device according to the invention is characterized in that it comprises at least one metallic support part made of a semiconducting metal or alloy and having said at least one external surface, which is covered with a ceramic coating specific to the invention and as presented above.

In a first advantageous embodiment of an external thermooptic control device, the support part is a metallic external layer of said semiconducting metal or alloy of a thermal blanket consisting of a multilayer assembly of sheets of low emissivity, each sheet of which consists of a synthetic core coated on both its faces with a layer of aluminum, two adjacent sheets being kept separated by a woven fabric, for example made of glass fibers or tergal, the ceramic coating covering said metallic layer of said thermal blanket.

In a second advantageous embodiment of an external device, the latter comprises at least one composite panel of honeycomb structure covered on at least one external face with an aluminum skin, the ceramic coating covering the external face of said aluminum skin.

In a third advantageous embodiment of an external thermooptic control device according to the invention, the ceramic coating covers at least one external face of a bulk metallic support part made of semiconducting metal or alloy belonging to an item of equipment, such as an optical sensor, support structure, waveguide or electronic box of the space vehicle, which projects outward on an external face of the platform of said space vehicle.

Other advantages and features of the invention will become apparent from the following nonlimiting description of embodiments with reference to the appended drawings in which:

FIGS. 1 and 2 show schematically a space vehicle with an external thermooptic control device, as described above, for presenting the main stresses imposed by the thermal environment in space of a spacecraft such as an artificial satellite;

FIG. 3 is a schematic representation in cross section of a metallic support part made of a metal or alloy based on what is called a semiconducting metal, one external face (turned toward space, in which the space vehicle is moving) of which is covered with a coating according to the invention, the metallic support part belonging to or constituting the external thermooptic control device;

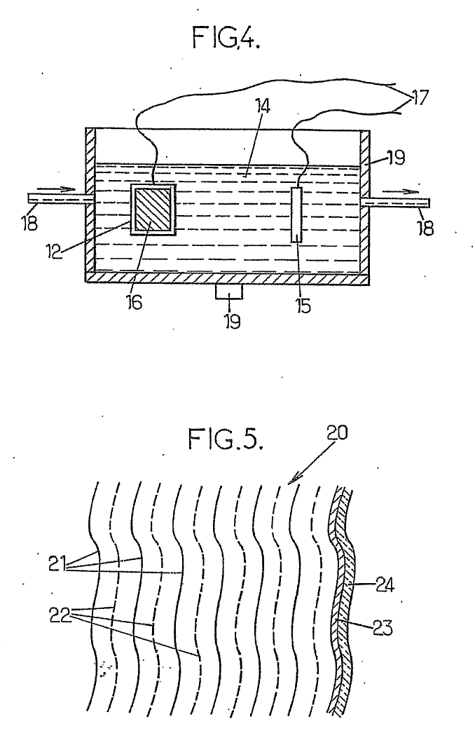

FIG. 4 is a schematic cross-sectional view of a tank containing an electrolyte bath with electrodes, pipes for the circulation of the electrolyte and an ultrasonic generator, for implementing the process according to the invention for depositing, by micro-arcs in the aqueous bath, a ceramic coating according to the invention; and

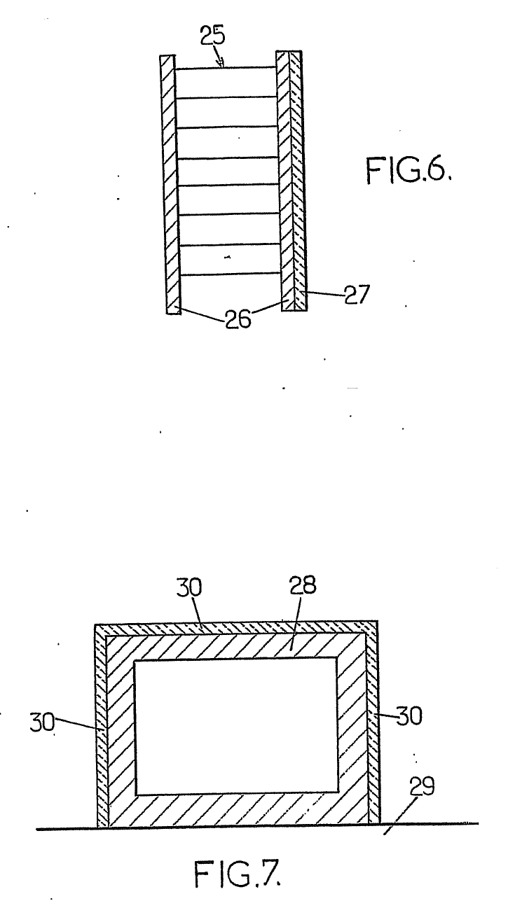

FIGS. 5, 6 and 7 show schematically, in cross section, three embodiments of an external thermooptic control device of at least one space vehicle element, one external surface of which device (intended to be turned toward space when the space vehicle is moving in the latter) is coated with a coating according to the invention, these three embodiments being, respectively, of a multilayer thermal blanket having an external metallic layer supporting a coating according to the invention, of a composite panel of honeycomb structure with an external skin made of semiconducting metal or alloy covered with a coating according to the invention, and of a bulk metallic casing for equipment of the space vehicle, one external face of which is covered with a coating according to the invention.

Shown in FIG. 3 as 12 is a metallic part forming part of an external thermooptic control device, such as 7 in FIGS. 1 and 2, or constituting such a device 7, this being a metallic support part or substrate made of a metal or alloy based on a semiconducting metal, or one having a “valve effect”, such as mainly aluminum or titanium, or else magnesium, hafnium or zirconium, the external face of which (turned toward space in which the space vehicle 1 in question, such as that in FIGS. 1 and 2, is moving) is covered with a ceramic coating. This coating essentially consists of two layers 10 and 11, which have been more clearly differentiated from each other and from the metallic support part 12 in the drawing than they would be in reality. Thus, the ceramic coating comprises an external layer 10, having a low solar absorptivity coefficient α (α less than 0.20 and preferably equal to or less than 0.15 typically), and which, in combination with an internal layer 11, constitutes a coating having a high hemispherical emissivity coefficient ε (ε being greater than 0.75 and typically between 0.8 and 0.9), and the internal layer 11 extends between the metallic support part 12 and the external layer 10 and is highly adherent to the metal of the support part 12, withstanding differential expansion stresses so as to make it possible to accommodate large expansion differences between the semiconducting metal or alloy 12 and the external ceramic layer 10, the coating being characterized by a low α/ε ratio of less than about 30% and preferably less than 20%.

In this ceramic coating, layers 10 and 11 of which together constitute an advantageous embodiment of the external face such as 8 (in FIG. 2) of the external thermooptic control device 7 of FIGS. 1 and 2, the internal 11 and external 10 layers covering the metallic support part 12 consist of different ceramics obtained in different crystalline forms of the semiconducting metal or alloy of the metallic part 12. The internal layer 11 is made of a low-density ceramic joined to the metallic support part 12 by interpenetration between the metal or alloy of this part 12 and the ceramic of the internal layer 11, which is a ceramic accommodating large strains, and mainly consisting of salts, of hydroxides and of the oxide phase of lowest enthalpy of the metal of the support part 12 or of the metal forming the basis of the alloy of this part 12.

In contrast, the external layer 10 of the ceramic coating is a dense white ceramic (having a higher density than that of the internal layer 11), consisting mainly of metal oxides of at least one highly enthalpic crystalline form of said semiconducting metal of the part 12 or of the metal forming the basis of the alloy of this part 12.

For example, if the ceramic of the external 10 and internal 11 layers is generated from titanium, this ceramic is mainly composed of titanium dioxide phases: rutile, brookite and, to a lesser extent, anatase. The concentration of brookite, silicates, hydrates and spinels is higher in the internal layer 11, close to the metallic substrate 12, thereby giving this internal layer 11 the capability of absorbing the differential expansion relative to the expansion of the metal part 12, in which the ceramic of the internal layer 11 is encrusted by oxidizing electrolytic growth by means of plasma micro-arcs in an ionized medium, and in particular in an aqueous bath, as described below with reference to FIG. 4. As regards this internal layer 11, it may be noted that the silicates, hydrates and spinels that it contains are encrusted impurities, which give this internal layer 11 a mechanical flexibility function facilitating the absorption of the aforementioned differential expansions.

In contrast, the concentration of rutile, which is denser than brookite and anatase, is greater in the external layer 10, thereby giving this layer 10 a white color, thus reducing the absorptivity of this external face 10.

In one advantageous embodiment, the external layer 10 is itself substantially subdivided into two sublayers, the internal sublayer of which, in contact with the internal layer 11, has a high rutile concentration, of preferably greater than 70%, giving the white color imparting a low absorptivity over the entire solar spectrum, and is covered by the external sublayer (toward the outside) made of vitrified ceramic, and therefore transparent, improving the hemispherical emissivity. It will be recalled that titanium oxide in the rutile form has the α-TiO₂ crystal form and that the high concentration of the rutile form in the external layer 10 makes it possible both to obtain a high degree of whiteness and thus to improve the low absorptivity characteristics and at the same time improves the high emissivity characteristic, which corresponds to a very low surface resistivity.

In the absence of a vitrified external sublayer, the outermost portion of the external layer (10) is that portion of the coating having the highest concentration, preferably greater than 70%, of the rutile form, which provides the whiteness and the low absorption and/or high emissivity characteristics.

However, in the internal layer 11, the less dense brookite and anatase phases of titanium oxide TiO₂ improve the ability to withstand large thermal differences, such as the ambient temperature passing to a temperature of +700° C., the ceramic coating thus constituted therefore being resistant to temperatures exceeding several hundred degrees Celsius.

If the ceramic of the layers 10 and 11 is generated from aluminum or from an aluminum-based alloy, and therefore if the metallic support part 12 is made of aluminum or an aluminum-based alloy, the internal layer 11 produced by a treatment of converting this part 12 is an interfacial layer having a high concentration (preferably greater than 70%) of the bohemite phase of aluminum oxide Al₂O₃, of salts and of hydroxides, whereas the external layer 10 has a high concentration (preferably greater than 70%) of dense white ceramic, consisting mainly of aluminum oxide of the α-Al₂O₃ crystal form called corundum.

Advantageously, a very high concentration (preferably greater than 90%) of corundum is achieved in the outermost part of the external layer 10, so as to obtain strong whiteness of this layer 10 and thus improve its low absorptivity characteristic and, at the same time, its high hemispherical emissitivity characteristic, corresponding to a very low surface resistivity.

In this embodiment also, it will be understood that the high concentration of the aforementioned low-density or lowest-density forms (bohemite phase, salts and hydroxides) in the internal layer 11, at the interface with the metallic support part 12, improves the capability of withstanding large thermal amplitudes, such as when the temperature passes from −100° C. to +300° C. for example.

The layers 10 and 11 of the ceramic coating according to the invention may be obtained by a process, specific to the invention, comprising several oxidizing electrolytic conversion steps, for converting, by means of micro-arcs, the semiconducting metal or alloy of the support part 12 in an ionized medium, which may be an oxidizing gas plasma, or else an aqueous bath, as described below with reference to FIG. 4.

Shown schematically in this FIG. 4 as 13 is a tank, preferably insoluble and made of stainless steel, containing an electrolyte bath 14 in which two electrodes are immersed, including a cathode 15, also insoluble and made of stainless steel, and an anode 16, which consists of or is enclosed by the metallic support part 12 made of semiconducting metal or alloy, the cathode 15 and the anode 16 each being connected to an electric current source via one of the two respective electrical conductors 17. Penetrating through side walls of the tank 13 are electrolyte pipes 18, these pipes allowing electrolyte to be treated in a closed circuit external to the tank 13, as indicated by the arrows in FIG. 4, for reasons explained below.

The electrolyte 14 is an aqueous-based solution comprising at least one oxyacid salt of an alkaline metal (potassium or sodium) and a hydroxide of an alkaline metal, which may be the same metal or, usually, a different alkaline metal than that corresponding to the oxyacide salt. This electrolyte 14 serves, firstly, to bring the outside of the metallic part 12 to be coated to the potential of the cathode 15. The electrolyte 14 then serves to convey the electric current from the cathode 15 to the anode 16 when arc plasmas are present. The electrolyte may contain particles of additional materials in suspension, which particles will be combined in the creation of the coating. These particles of additional materials may be PTFE particles in order to reduce friction, or diamond particles in order to harden the ceramic coating.

Through intense convection, provided in particular by the circulation of the electrolyte 14 through the tank 13 and outside the latter via the pipes 18, in a closed circuit, the electrolyte 14 discharges the heat created by the joule effect, owing to the flow of the electric current from the cathode 15 to the anode 16. The cathode 15 conducts the electric current and is insoluble in the electrolyte 14, which is the reason why the cathode is in particular made of stainless steel or nickel.

In order for arcs to be able to develop at the surface of the metallic part 12 to be coated with the ceramic coating, this semiconducting metal or alloy part 12 is firstly covered naturally with an electrically insulating layer in the first phase of the process.

In such a process for oxidizing electrolytic conversion by micro-arcs, in an aqueous bath, or else in an ionized gas containing oxygen, in order to obtain a ceramic coating on the surface of a semiconducting metal or alloy, it is known that the crystalline form of the ceramic thus created is mainly determined by the temperature of the plasma. For example in the case of aluminum, in the presence of oxygen (present in water), α-Al₂O₃ (corundum) is created at high temperature and γ-Al₂O₃ (bohemite) is created at lower temperature. In the case of titanium, this metal oxidizes to TiO₂ in rutile, brookite or anatase form depending on the temperature of formation.

The first step therefore consists in creating an electrically insulating layer on the external surface of the metallic part 12 to be covered with the ceramic coating, this electrically insulating layer being mainly formed from hydroxides. This insulating layer may be created by an electric current or by one of the anodic oxidations commonly used in electrolysis. This electrically insulating layer, necessary for starting the deposition process, has no particular quality, and will therefore be destroyed at the end of the multi-step process for depositing the ceramic coating or, advantageously, it will be utilized by vitrification, as explained below.

The second step consists in creating the external ceramic layer 10, which is the main layer, having the desired thermooptic characteristics, in particular for the aforementioned space applications. This external layer 10 is dense, since pores in this layer, if larger than a fraction of the wavelength of the incident light, would become sites of light absorption. This external layer 10 is white, as it is desired to have a low solar absorptivity, and, by being very white, this layer 10 thus reflects all the wavelengths of the solar spectrum. For this reason, said external layer 10 mainly consists of oxides that are formed at high temperatures (corundum in the case of an aluminum support part 12 and rutile in the case of a titanium support part 12). During this second step, the formation of hydroxides is avoided as much as possible since these are radiation-sensitive and their presence in this dense external layer 10 of the coating would embrittle the coating, accelerating its aging in the harsh environment that constitutes the space environment. For this purpose, said second step is carried out in an aqueous electrolyte having a low concentration of oxyacid salt of an alkaline metal (potassium or sodium for example) and a low concentration of hydroxides and/or peroxides of an alkaline metal, typically 2 to 20 g/l. The electrolyte bath 14 is therefore changed, or its concentration is altered progressively by a suitable treatment of the electrolyte 14 in the closed circuit via the pipes 18, and outside of the tank 13. This step for forming the external dense ceramic layer 10 of the coating, beneath the electrically insulating layer produced during the first step, is continued until the micro-arc strike voltage exceeds about 1000 volts.

To further densify the ceramic deposit, ultrasonic waves may be introduced into the electrolyte bath 14 and, for this purpose, an ultrasonic generator 19 may be placed against and beneath the bottom of the tank 13, as shown in FIG. 4.

In addition, to promote crystalline oxide growth, which makes the ceramic coating more stable over time under the impact of high-energy waves and particles striking it, it is preferable to add particular salts to the electrolyte bath 14, for example copper and/or lanthanum salts, promoting the formation of the crystalline phase, that is to say promoting the growth of an oxide form of high enthalpy.

Furthermore, during this second step, the electrolyte 14 is vigorously cooled so as to keep the ceramic deposit as cold as possible. This is because the insulation resistance of the deposit decreases with temperature. Therefore, to have a large joule effect in creating the micro-arcs, the insulation resistance must be high.

The third step of the process, to create the internal layer 11 or interface layer, is carried out in an electrolyte bath 14 having a very high concentration (almost at saturation) of an oxyacid salt of an alkaline metal, such as potassium or sodium, so as to promote the growth of hydroxides. The voltage/intensity profile of the electric current applied to the electrodes 15-16, in other words the electric current form factors, the potential, frequency and intensity of the current applied to the electrodes, are chosen in such a way that the micro-arcs are rapidly extinguished within a time of less than about 1 microsecond, so as to lower the temperature of the arc.

In addition, the circulation of the electrolyte 14 during this third step is less intense, so as to increase the temperature of the electrolyte 14, and therefore the temperature of the insulating coating, and therefore its resistivity. However, to prevent the water of the electrolyte 14 from boiling, the entire bath may be kept under pressure in an autoclave container, formed by sealing the tank 13, or by placing this tank 13 in an autoclave container.

In a first variant of the process according to the invention for forming the ceramic coating, the electrically insulating layer, formed during the first step, is removed during a fourth step which, for example, is carried out in a bath for dissolving the hydroxides and salts, for example a dilute hydrofluoric acid bath, or a potassium hydroxide bath, since amphoteric elements are present.

In this variant, during the fourth step, it is also advantageous to transmit ultrasonic waves through the dissolving bath, so as to create interfacial micro-implosions, and thus provide an ultrasonic compacting action, enabling any pores remaining in the ceramic deposit to be eliminated, after removal of the electrically insulating layer.

In another method of implementing this variant of the deposition process of the invention, the fourth step, consisting in removing the electrically insulating layer, may be carried out by at least one mechanical operation.

For example, this may be a polishing operation or else a micro-peening operation (blasting with metal microbeads) so as to remove the porous surface part rich in hydroxides and salts (silicates, etc.) constituting this electrically insulating layer.

However, according to another, more advantageous, variant of the deposition process according to the invention, the electrically insulating layer deposited during the first step is not removed, but utilized by being vitrified during a fourth step, this vitrification taking place by dehydrating the hydroxides of this electrically insulating layer through the action of a high temperature, for example by passage through a furnace, or by exposing this electrically insulating layer to a pulsed high-power laser. This vitrification has the effect of making this layer transparent, which becomes the outer sublayer of the external layer 10 of FIG. 3, the emissivity of which is improved without the solar reflection being degraded.

This process for depositing the ceramic coating, in particular in its advantageous variant that includes the vitrification of the electrically insulating layer deposited during the first step, makes it possible to obtain a coating (10-11) having very specific characteristics useful for thermooptic control applications in space, such as those mentioned above, namely a very high hemispherical emissivity, a very low solar absorptivity, very good temperature resistance, non-aging in the harsh environment, namely the space environment, and very good adhesion to the semiconducting metal supports, thanks to the flexibility of the internal layer 11, accommodating large thermoelastic and bending strains.

Thanks to these characteristics, this type of ceramic coating may be used on board space vehicles, such as artificial satellites, on several forms of structures for external thermooptic control devices, three examples of which are described below, without implying any limitation, since this coating may be used on any external radiative surface of space vehicles.

The first application example is a multilayer thermal blanket having a semiconducting external metallic layer covered with a ceramic coating according to the invention, as shown in FIG. 5.

This thermal blanket, identified in its entirety by the reference 20, is commonly called an MLI (multilayer insulation) blanket in the space industry field and consists of a multilayer assembly of low-emissivity sheets 21. Each of the sheets 21 is formed from a central layer or core made of a synthetic material, for example those known by the trade marks Kapton and Mylar, which is coated on both its sides with an aluminum layer deposited by vacuum evaporation. Each sheet 21 is kept apart from a neighboring sheet 21 by a woven fabric 22, for example made of glass or of TERGAL®. By applying the Stefan-Boltzmann law between the sheets 21, it is found that the thermal flux passing through such a multilayer blanket is practically zero. Consequently, the coating of the external layer receives only external energy fluxes. Said external layer 23 is a metallic layer made of a semiconducting metal or alloy, on the external face of which an external ceramic coating 24 according to the invention is produced by a conversion treatment. The assembly of the external metallic layer 23 and of the external coating 24 thus has a thickness that can vary, for example, from about 60 μm to about 100 μm.

The ceramic coating 24 of the external metallic layer 23 receives the solar flux in the visible band and emits in the infrared in a band and with a flux that depend on its temperature. For a high solar flux, the temperature of the external ceramic coating 24 may exceed about 300° C., which temperature said coating 24 is perfectly capable of durably withstanding, for the abovementioned reasons.

The second application example, shown in FIG. 6, is a panel of honeycomb structure that can be used for the external walls of an artificial satellite, especially in geostationary orbit. It is known that the walls on the North and South of such a satellite are structural elements that have to provide a radiator function. In addition, the antenna reflectors of such satellites are also structural elements, having a perfectly defined shape, and these must not vary with thermal variations. For these two structural applications, it is therefore necessary to guarantee thermooptic properties such that the ratio of absorptivity to emissivity, α/ε, is very low. To produce these North and South walls and/or these antenna reflectors, composite panels of honeycomb structure are often used, such as the panel 25 in FIG. 6, coated on each of its two faces with a foil forming an aluminum skin 26, the external skin of which (on the right in FIG. 6) is coated with an external ceramic coating 27 according to the invention, the combination of this external aluminum skin 26 and of this ceramic coating 27 having a thickness of between about 150 μm and about 500 μm.

The third example, shown in FIG. 7, is that of a metal casing 28, made of an aluminum alloy or titanium alloy, constituting a case or box, fixed so as to project outwardly on an external face of the platform 29 of a satellite and produced in the form of a bulk part made of a semiconducting alloy, the external faces of which are covered with an external ceramic coating 30 according to the invention, the combination of the casing 28 and of the coating 30 being able to have a thickness of a few millimeters. Such metal casings 28 may house equipment such as optical sensors, antenna support structures, waveguides or any other electronic packages that have to be placed on the outside of the platform of the space vehicle or satellite. The external surfaces of such equipment will thus have the thermooptic properties giving them a very low α/ε ratio, as already mentioned above.

1. A coating for an external device for thermooptically controlling at least one element of a space vehicle, wherein said coating is produced by a conversion treatment, for converting at least one external surface of at least one metallic support part of said external device, and is resistant to radiative stresses encountered in space, said coating comprising:
an internal layer, in contact with said external surface of said metallic support part, which internal layer is highly adherent to said metallic support part and withstands differential expansion stresses relative to said metallic support part; and
an external layer, in contact on one side with said internal layer and on the other side with the space environment in which said device moves, said external layer having a low solar absorptivity characteristic α;
said external and internal layers covering said external surface of said metallic support part, consisting of ceramics differing from one layer to the other, and obtained from different crystalline forms of said metal or alloy of said metallic support part;
said external and internal layers together having a high hemispherical emissivity characteristic ε; and
the solar absorptivity characteristics α of said external layer and the emissivity characteristics ε of both said external and internal layers being such that the ratio α/ε is less than about 30% and preferably less than 20%.

2. The coating as claimed in claim 1, wherein said external layer has a solar absorptivity characteristic α of less than about 0.20 and preferably less than 0.15.

3. The coating as claimed in claim 1, wherein said external and internal layers together have an emissivity characteristic ε of greater than about 0.75 and preferably between 0.8 and 0.9.

4. The coating as claimed in claim 1, which is resistant to temperatures of at least 200° C.

5. The coating as claimed in claim 1, wherein there is interpenetration of at least one ceramic of said internal layer with said metal or alloy of said metallic support part.

6. The coating as claimed in claim 1, wherein said ceramics of said layers of said coating are crystalline forms of “semiconducting”-type metal or alloy, or one having a “valve effect”, of said metallic support part.

7. The coating as claimed in claim 1, wherein said internal layer is a ceramic withstanding large deformations, possibly in excess of 100%, and essentially consisting of salts, hydroxides and the oxide phase of lowest enthalpy of said metal or alloy of said metallic support part.

8. The coating as claimed in claim 1, wherein said external layer is made of a white ceramic denser than said ceramic of said internal layer and essentially consisting of the oxide phase of at least one highly enthalpic crystalline form of said metal or alloy of said metallic support part.

9. The coating as claimed in claim 8, wherein an internal portion, in contact with said internal layer, of said external layer is of white color, having a low absorptivity over the entire solar spectrum, and is covered, toward the outside, by a transparent vitrified ceramic layer improving the emissivity.

10. The coating as claimed in claim 1, which is produced by a conversion treatment, for converting at least one external surface of a support part made of aluminum or aluminum alloy, and said internal layer is an aluminum/alumina interface layer having a high concentration of salts, of hydroxides and of the bohemite phase of aluminum oxide Al₂O₃, and said external layer is made of a dense white ceramic, essentially consisting of aluminum oxide of the α-Al₂O₃ crystal form called corundum.

11. The coating as claimed in claim 10, wherein an outermost portion of said external layer is produced with a very high concentration of corundum, preferably greater than 90%, providing strong whiteness and improving the low absorptivity and/or high emissivity property.

12. The coating as claimed in claim 1, which is produced by a conversion treatment, for converting at least one external surface of a support part made of titanium or titanium alloy, said internal layer being an interfacial layer between, on the one hand, the titanium or said titanium alloy and, on the other hand, at least one amorphous titanium oxide, and salts, hydroxides and brookite and anatase phases of titanium oxide TiO₂, and said external layer is made of a dense white ceramic essentially consisting of titanium oxide in the α-TiO₂ crystal form called the rutile form.

13. The coating as claimed in claim 12, wherein an outermost portion of said external layer has a high concentration, preferably greater than 70%, of the rutile form improving the low absorptivity property.

14. A process for forming a ceramic coating on at least one external surface of at least one support part made of a semiconducting metal or alloy, or one having a “valve effect”, by oxidizing electrolytic conversion, by means of micro-arcs in an ionized medium, of said semiconducting metal or alloy, wherein said electrolytic conversion is obtained by a multi-step treatment in an aqueous bath or in a gaseous plasma, and in that, after a 1st step consisting in forming an electrically insulating, essentially hydroxide, layer then a 2nd step, consisting in forming an external ceramic layer of said coating beneath said electrically insulating layer, a 3rd step consists in forming an internal ceramic, also beneath said electrically insulating layer.

15. The process as claimed in claim 14, in which said electrolytic conversion is provided in an aqueous bath and said 2nd step of forming said external layer of said coating is carried out in an aqueous electrolyte comprising at least one oxyacid salt of an alkaline metal and a hydroxide of an alkaline metal, wherein, in said 2nd step, said aqueous electrolyte has a low concentration of oxyacid salt of said alkaline metal, preferably potassium or sodium, and a low concentration of hydroxide and/or peroxide of an alkaline metal, and said 3rd step is carried out in a bath having a very high concentration of oxyacid salt of an alkaline metal, so as to promote hydroxide growth with an electric voltage/current profile applied to electrodes, an anode of which at least partly consists of said support part made of said semiconducting metal or alloy, chosen in such a way that said micro-arcs are extinguished rapidly so as to maintain a low oxide formation temperature.

16. The process as claimed in claim 15, wherein said 2nd step is continued until the micro-arc strike voltage exceeds about 1000 V.

17. The process as claimed in claim 15, wherein during said 2nd step, said electrolyte is strongly cooled so as to keep the deposit of said external ceramic layer cold.

18. The process as claimed in claim 15, wherein ultrasonic waves are transmitted through said electrolyte, during said 2nd step so as to densify the external ceramic layer.

19. The process as claimed in claim 15, wherein during said second step, at least one salt, preferably a copper and/or lanthanum salt, is introduced into said electrolytic bath so as to promote the growth of an oxide form of high enthalpy and to stabilize the deposit of said external ceramic layer over time.

20. The process as claimed in claim 15, wherein during the 3rd step, the temperature of said electrolyte is increased, preferably by reducing the intensity of circulation of said electrolyte and, preferably, said bath is kept under pressure in an autoclave container so as to prevent water of said electrolyte from boiling.

21. The process as claimed in claim 14, including a 4th step, consisting in removing said electrically insulating layer formed during said 1st step.

22. The process as claimed in claim 21, wherein the removal of said electrically insulating layer is carried out in a bath for dissolving said hydroxides and salts, preferably a dilute hydrofluoric acid bath or a potassium hydroxide bath.

23. The process as claimed in claim 22, wherein during said 4th step, ultrasonic waves are transmitted through said dissolving bath so as to exert compacting action for eliminating pores remaining in said ceramic coating after removal of the electrically insulating layer.

24. The process as claimed in claim 21, wherein said 4th step of removing said electrically insulating layer is carried out by means of at least one mechanical operation, preferably by micro-peening and/or by polishing, so as to remove a porous surface portion rich in hydroxides and salts, especially silicates, of said ceramic coating.

25. The process as claimed in claim 14, including a 4th step consisting in vitrifying said electrically insulating layer deposited during said 1st step, so as to make said insulating layer transparent and to improve the emissivity without degrading the solar reflection, the vitrification comprising a dehydration of hydroxides, preferably through the action of a high temperature in a furnace or by using a pulsed high-power laser.

26. An external device for thermooptically controlling at least one element of a space vehicle, having at least one external surface intended to be turned toward space when said space vehicle moves in said space, and is coated with a coating resistant to the thermal and radiative stresses specific to the space environment, and having a high emissivity and a low absorptivity, wherein said external device comprises at least one metallic support part made of a semiconducting metal or alloy and having said at least one external surface, which is covered with a ceramic coating as claimed in claim 1.

27. The external thermooptic control device as claimed in claim 26, wherein said support part is a metallic external layer of said semiconducting metal or alloy of a thermal blanket consisting of a multilayer assembly of sheets of low emissivity, each sheet of which consists of a synthetic core coated on both faces of said core with a layer of aluminum, two adjacent sheets being kept separated by a woven fabric, preferably made of glass fibers or tergal, said ceramic coating covering said metallic layer of said thermal blanket.

28. The external thermooptic control device as claimed in claim 26, comprising at least one composite panel of honeycomb structure covered on at least one external face with an aluminum skin, said ceramic coating covering an external face of said aluminum skin.

29. The external thermooptic control device as claimed in claim 26, wherein said ceramic coating covers at least one external face of a bulk metallic support part made of semiconducting metal or alloy belonging to an item of equipment, preferably an optical sensor, support structure, waveguide or electronic box of the space vehicle, which projects outward on an external face of a platform of said space vehicle.
